(19) United States
(12) Patent Application Publication
(10) Pub. No.: US 2019/0340254 A1
(43) Pub. Date: Nov. 7, 2019

(54) ADJUSTING MEDIA OUTPUT BASED ON MOOD ANALYSIS

(71) Applicant: INTERNATIONAL BUSINESS MACHINES CORPORATION, Armonk, NY (US)

(72) Inventors: PASQUALE A. CATALANO, WALLKILL, NY (US); JOHN S. WERNER, FISHKILL, NY (US); ANDREW G. CRIMMINS, MONTROSE, NY (US); ARKADIY O. TSFASMAN, WAPPINGERS FALLS, NY (US)

(21) Appl. No.: 15/970,081

(22) Filed: May 3, 2018

(51) Int. Cl. G06F 17/30; G10L 25/63; H04L 12/58; H04L 29/08

(52) U.S. Cl. CPC G06F 17/30032; H04L 67/306; H04L 51/32; G10L 25/63

(57) ABSTRACT

Methods, systems and computer program products for adjusting media output based on mood analysis are provided. Aspects include determining a sentiment of a user based on a communication of a user. Based on a determination that the sentiment is negative, aspects include obtaining a media item having a positive sentiment ranking based on a user profile of the user and monitoring the sentiment of the user during playback of the media item. Based on a determination that the sentiment of the user became more positive during playback the media item, aspects include increasing the positive sentiment ranking of the media item. Based on a determination that the sentiment of the user did not become more positive during playback the media item, aspects include decreasing the positive sentiment ranking of the media item.

### BACKGROUND

The invention relates generally to adjusting media output and, more specifically, to adjusting media output based on mood analysis.

The mood, or sentiment, of an individual can change when they are engaged in communications or other activities, such as texting, talking and the like. These changes in sentiment can affect the tone of their conversations and their word choice, which can negatively impact the effectiveness of their communication. In addition, the negative sentiment of an individual can negatively impact both the individual the person that they are communicating with after the communication is complete (e.g., a personal phone call may upset a user which negatively impacts their performance at work for the rest of the day).

### SUMMARY

According to an embodiment, a system for adjusting media output based on mood analysis is provided. The system includes a memory having computer readable computer instructions, and a processor for executing the computer readable instructions. The computer readable instructions include determining a sentiment of a user based on a communication of a user. Based on a determination that the sentiment is negative, the computer readable instructions include obtaining a media item having a positive sentiment ranking based on a user profile of the user and monitoring the sentiment of the user during playback of the media item. Based on a determination that the sentiment of the user became more positive during playback the media item, the computer readable instructions include increasing the positive sentiment ranking of the media item. Based on a determination that the sentiment of the user did not become more positive during playback the media item, the computer readable instructions include decreasing the positive sentiment ranking of the media item.

According to another embodiment, a method adjusting media output based on mood analysis is provided. The method includes determining a sentiment of a user based on a communication of a user. Based on a determination that the sentiment is negative, the method includes obtaining a media item having a positive sentiment ranking based on a user profile of the user and monitoring the sentiment of the user during playback of the media item. Based on a determination that the sentiment of the user became more positive during playback the media item, the method includes increasing the positive sentiment ranking of the media item. Based on a determination that the sentiment of the user did not become more positive during playback the media item, the method includes decreasing the positive sentiment ranking of the media item.

According to a further embodiment, a computer program product is provided. The computer program product includes a computer readable storage medium having program instructions embodied therewith. The computer readable storage medium is not a transitory signal per se. The program instructions are executable by a computer processor to cause the computer processor to perform a method. The method includes determining a sentiment of a user based on a communication of a user. Based on a determination that the sentiment is negative, the method includes obtaining a media item having a positive sentiment ranking based on a user profile of the user and monitoring the sentiment of the user during playback of the media item. Based on a determination that the sentiment of the user became more positive during playback the media item, the method includes increasing the positive sentiment ranking of the media item. Based on a determination that the sentiment of the user did not become more positive during playback the media item, the method includes decreasing the positive sentiment ranking of the media item.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, in which:

FIG. 1 depicts a cloud computing environment according to one or more embodiments of the present invention;

FIG. 2 depicts abstraction model layers according to one or more embodiments of the present invention;

FIG. 3 depicts an exemplary computer system capable of implementing one or more embodiments of the present invention;

FIG. 4 depicts a system upon which adjusting media output based on mood analysis may be implemented according to one or more embodiments of the present invention;

FIG. 5 depicts a flow diagram of a method for adjusting media output based on mood analysis according to one or more embodiments of the present invention; and

FIG. 6 depicts a flow diagram of another method for adjusting media output based on mood analysis according to one or more embodiments of the present invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist, on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist, on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

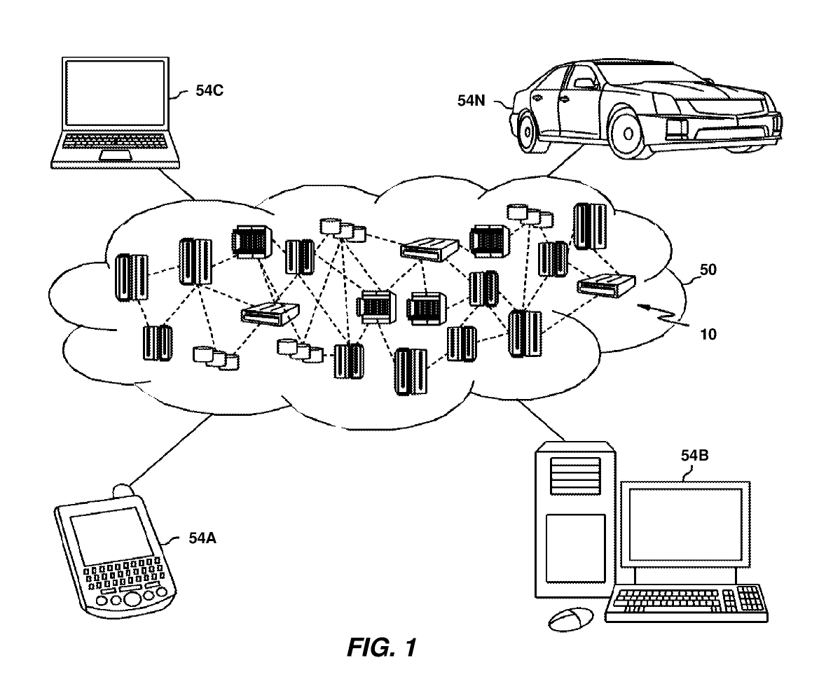

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

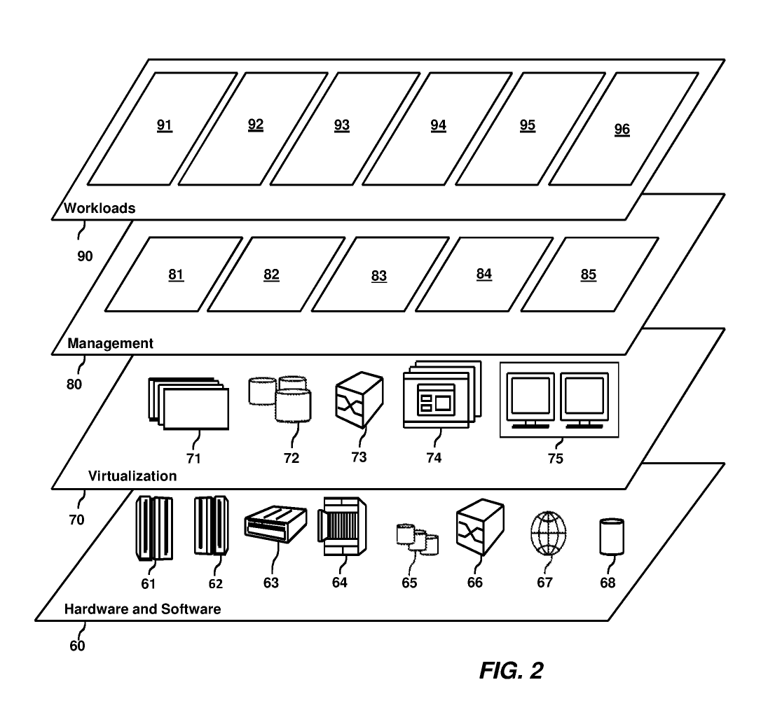

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adjusting media output based on mood analysis 96.

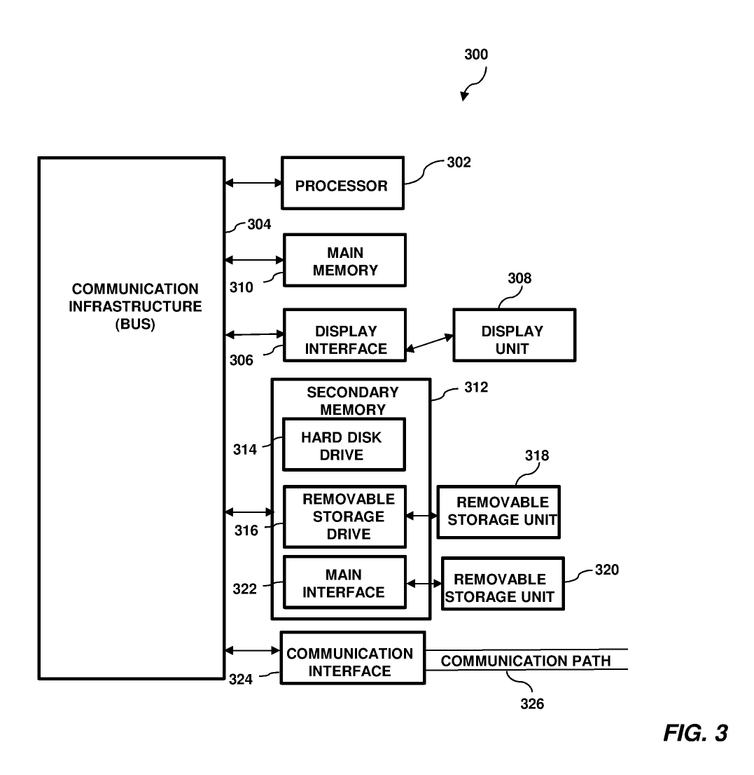

Turning now to a more detailed description of aspects of the present invention, FIG. 3 illustrates a high-level block diagram showing an example of a computer-based system 300 useful for implementing one or more embodiments of the invention. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional systems are in communication via communication path 326, (e.g., to communicate data between them).

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by a removable storage drive 316. As will be appreciated, removable storage unit 318 includes a computer readable medium having stored therein computer software and/or data.

In some alternative embodiments of the invention, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etc. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310, and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

In exemplary embodiments, a system for adjusting media output based on mood analysis is configured to monitor the communications of a user and to determine a sentiment of the used based on their communications. Based on a determination that the user has a negative sentiment, the system causes the playback of a media item that has a positive sentiment association with the user to cause an increase in the sentiment of the user. In exemplary embodiments, the system can monitor written communication and/or oral communication of the user. The system is configured to identify media items that are playing when it determines that the user has a positive sentiment and to add these media items to a user profile of the user. In exemplary embodiments, the system adjusts a positive sentiment score associated with the media items in the user profile based on detected changes in user sentiment when the media item is played.

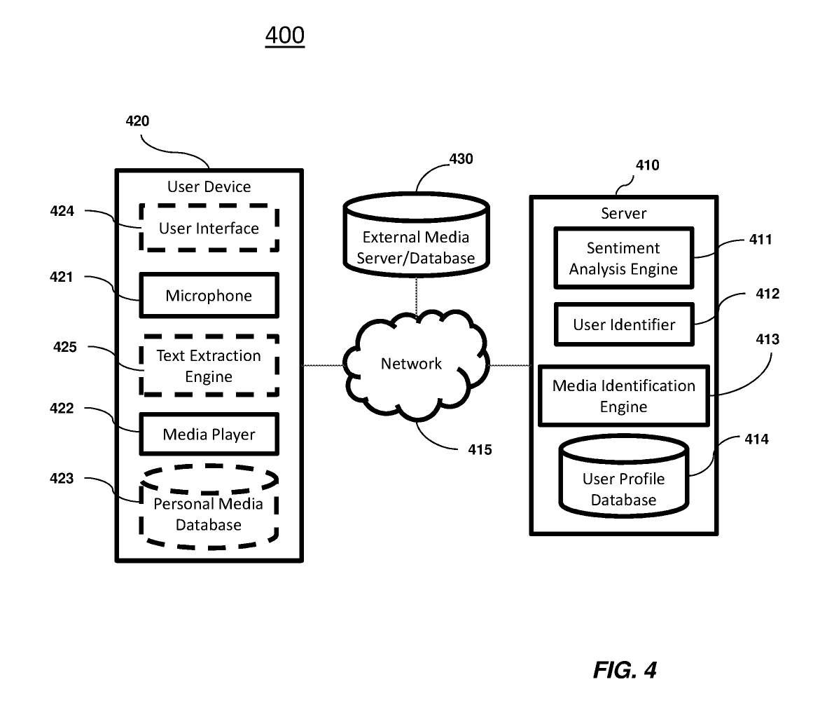

Turning now to FIG. 4, a system 400 upon which adjusting media output based on mood analysis may be implemented will now be described in accordance with an embodiment. The system 400 shown in FIG. 4 includes a server 410 in communication with a user device 420 via a communications network 415. The communications network 415 may be one or more of, or a combination of, public (e.g., Internet), private (e.g., local area network, wide area network, virtual private network), and may include wireless and wireline transmission systems (e.g., satellite, cellular network, terrestrial networks, etc.). In addition, the user device 420 and the server 410 are in communication with an external media database 430. In exemplary embodiments, the external media database 430 is configured to store media items that can be accessed and played by the user device 420. In exemplary embodiments, the external media database 430 may also include a profile on a streaming service that is updated such that preferred media content can be streamed later. Although illustrated as separate devices, it will be clear to those of ordinary skill in the art that external media database 430 may be part of the user device 420.

In exemplary embodiments, the user device 420 can be a smartphone, a tablet, a computer system such as the one shown in FIG. 3, a smart speaker, a television, or any other suitable electronic device. The user device 420 includes a microphone 421 and a media player 422 capable of playing a media item. Optionally, the user device 420 can also include a personal media database 423, a user interface 424 and a text extraction engine 425. In exemplary embodiments, the personal media database 423 is configured to store media items that can be played by the user device 420. The user interface 424 can be a graphical user interface such as a touchscreen, a keyboard, or the like. The text extraction engine 425 is configured to extract text from written and/or oral communication of the user.

In exemplary embodiments, the user device 420 is configured to capture communications of the user, either via the microphone 421 or the text extraction engine 425, and to provide the communications to the server 410. The server 410 includes a sentiment analysis engine 411, a user identifier 412, a media identification engine 413, and a user profile database 414. The sentiment analysis engine 411 is configured to analyze the communications of the user captured by the user device 420 and to identify the sentiment of the user. In exemplary embodiments, the sentiment analysis engine 411 can use any of a variety of known techniques to identify the sentiment of the user (e.g., IBM Watson® Natural Language Understanding and Tone Analyzer). The user identifier 412 is used to identify the user in the communication data. For example, the communication may be a captured oral conversation between the user and another person and the user identifier 412 can be a voice recognition module configured to detect which voice is the user's voice.

The server 410 also includes a media identification engine 413 that is configured to identify a media item that is detected by the user device 420. For example, during a conversation, the microphone 421 may capture background audio of a song in addition to the voice of the user. The media identification engine 413 is configured to identify the song that was captured. In exemplary embodiments, the user device 420 device may be configured to monitor the user even when the user device 420 is not in use (e.g., when the user device 420 is in their pocket, in their purse, on the table, etc.). As a result, the user device 420 can detect background music and in-person conversations to use this information to determine a user's sentiment and how the sentiment is affected or changed by background music. The server 410 further includes a user profile database 414 that stores information regarding media items that have a positive sentiment score, or ranking, for the user. The positive sentiment scores of the media items stored in the user profile can be adjusted based on the detected change in a user's sentiment as the media object is played. The user profile database 414 can also store information regarding the user such as the user's age, gender, purchases, media consumption history, user communication history, and the like.

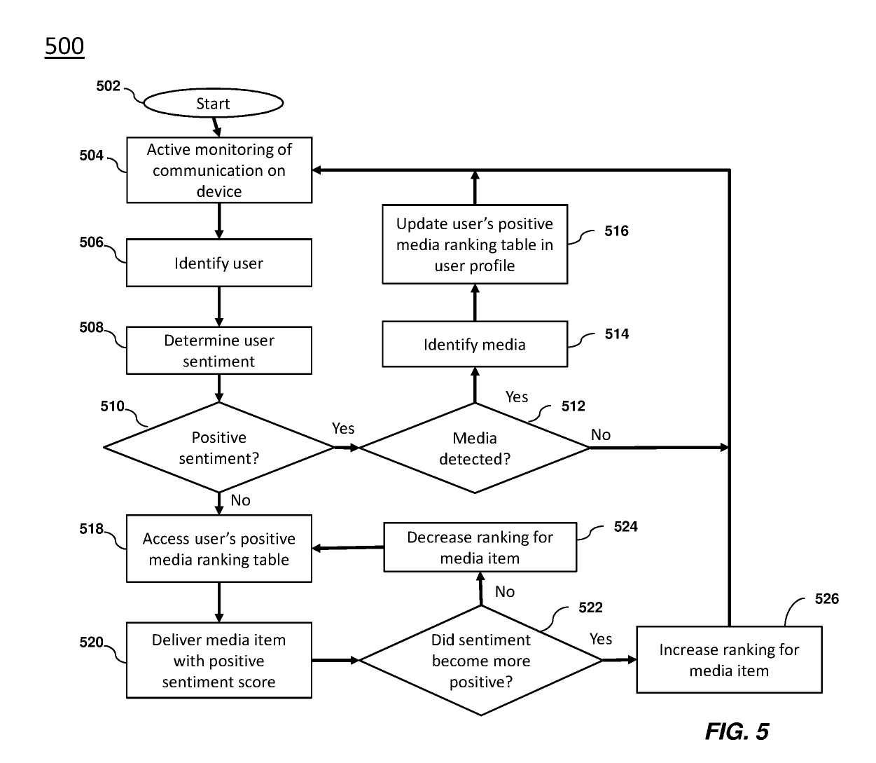

Turning now to FIG. 5, a flow diagram of a method 500 for adjusting media output based on mood analysis in accordance with an embodiment is shown. The method 500 begins at block 502 and actively monitors the communications of a user, as shown at block 504. In various embodiments, the communications of a user can include written communications such as emails, text messages, instant messages, and/or oral communications between the user and one or more other people. In addition, the communication monitoring can be performed whether the device is in use (e.g., the user is making a phone call) or not in use (e.g., the user device is in the pocket of a user while the user is talking to someone in person). Next, as shown at block 506, the method 500 includes determining the identity of the user. The identity of the user can be determined based on voice recognition, facial recognition, user logon information, user device identification or the like. Next, as shown at block 508, the method 500 includes determining a sentiment of the user based on an analysis of the communication of the user.

As shown at decision block 510, the method 500 includes determining if the user sentiment is positive. In exemplary embodiments, the sentiment analysis engine can return a sentiment score and sentiments having a score above a threshold level can be classified as a positive sentiment, sentiments having a score below another threshold level can be classified as a negative sentiment. If the user sentiment is positive, the method proceeds to decision block 512 and determines if a media item is detected. If a media item is detected, the method 500 proceeds to block 514 and identifies the media item. In exemplary embodiments, the media item can be identified by a media identification engine using any of a variety of known techniques. Once the media item has been identified, the method 500 proceeds to block 516 and updates the user profile to include the media item and the positive sentiment rating or score. If the media identified already exists in the user profile, then the media ranking is increased. In some embodiments, the method may decipher whether the user's mood is positive based on the conversation rather than the recognized media and will only update the user profile if the media is expected to be the cause of the positive sentiment. If a media item is not detected, the method returns to block 504 and continues to monitor the communications of the user.

Continuing with reference to FIG. 5, if, as shown at decision block 510, the user sentiment is negative, the method 500 proceeds to block 518 and accesses the user profile of the user to identify media items having a positive sentiment score or ranking. Next, as shown at block 520, the method 500 includes delivering a media item with a positive sentiment score. In one embodiment, the media content with the highest sentiment score and/or ranking can be played. In another embodiment, the media content with a sentiment score and/or ranking above a threshold level that was most recently added to the user profile can be played. In another embodiment, any media within the user profile that is above a threshold sentiment score may be randomly selected. In some embodiments, media may only be played or changed if the user is currently watching or listening to other media. In some embodiments, when media was not currently playing, analysis of the current conversation may determine if it is appropriate to begin playing media (e.g., if analysis of the current conversation determine the user is at work, media may not begin playing, but if the user is determined to be at home preparing dinner, media may begin playing). Next, as shown at decision block 522, the method 500 includes monitoring the user communications and determining if the sentiment of the user has become more positive in response to the selected media. If the sentiment of the user has become more positive, the method 500 proceeds to block 526 and increases the ranking/score for the media item. Otherwise, as shown at block 524, the sentiment score and/or ranking is decreased for the media item before returning to block 518 to select alternate media.

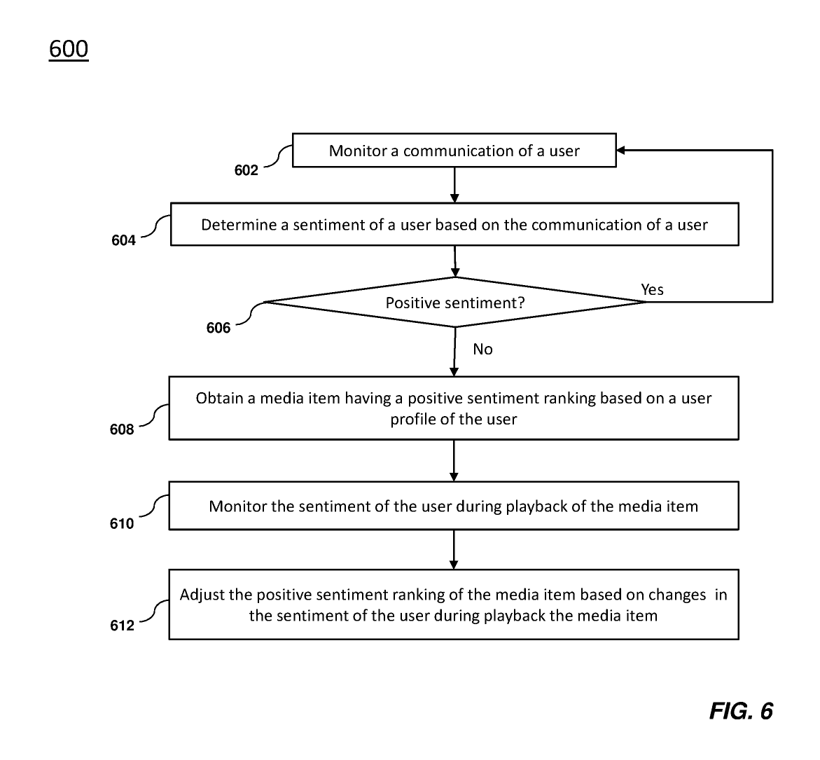

Turning now to FIG. 6, a flow diagram of a method 600 for adjusting media output based on mood analysis in accordance with an embodiment is shown. As shown at block 602, the method 600 includes monitoring a communication of a user. Next, as shown at block 604, the method 600 includes determining a sentiment of a user based on the communication of a user. At decision block 606, the method includes determining if the sentiment is positive. If the sentiment is positive, the method 600 returns to block 602 and continues to monitor the communications of the user. If the sentiment is not positive, the method 600 proceeds to block 608 and obtains a media item having a positive sentiment ranking based on a user profile of the user. Next, as shown at block 610, the method 600 includes monitoring the sentiment of the user during playback of the media item. The positive sentiment ranking of the media item is adjusted based on changes in the sentiment of the user during playback of the media item, as shown at block 612. For example, if the user sentiment improves or goes up, the positive sentiment ranking of the media item is increased and if the user sentiment decreases or goes down, the positive sentiment ranking of the media item is decreased.

In exemplary embodiments, the user communication captured by the user device can be a conversation between the user and another person. The communication information is sent to the server and the server identities both the user and the other person. Upon determining that both the user and the other person have user profiles stored on the server, the server identifies a media item that has a positive sentiment score that is present in both user profiles. The identified media item is then played via the user device. The sentiment of both users is then monitored and the sentiment scores of the media item for both parties is updated based on a detected change in their sentiment.

In exemplary embodiments, the user device can cause other changes in the environment of the user based on the detected sentiment of the user. For example, if the user device is a smart home device or a smartphone with connected smart home applications, the user device can utilize the functionally of the smart home applications to alter the lighting of the environment the user is in, change the temperature of the environment the user is in, or the like. In another embodiment, if the user device is a computer, smartphone, tablet or the like the screen color or background images of the device can be changed based on the detected sentiment.

In exemplary embodiments, by detecting negative sentiment and playing media content items that are effective in providing a positive impact on the user sentiment, the effectiveness of the user communication can be increased. This increase can take the form of a communication with a more positive overall tone that is more likely to be well received by the intended recipient.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for adjusting media output based on mood analysis, comprising:
a memory having computer readable instructions; and
a processor for executing the computer readable instructions, the computer readable instructions including:
determining a sentiment of a user based on a communication of a user;
based on a determination that the sentiment is negative:
obtaining a media item having a positive sentiment ranking based on a user profile of the user;
monitoring the sentiment of the user during playback of the media item;
based on a determination that the sentiment of the user became more positive during playback the media item, increasing the positive sentiment ranking of the media item; and
based on a determination that the sentiment of the user did not become more positive during playback the media item, decreasing the positive sentiment ranking of the media item.

2. The system of claim 1, wherein the computer readable instructions further include identifying a media item playing based on a determination that the sentiment is positive.

3. The system of claim 2, wherein the computer readable instructions further include adding the media item to the user profile with a default positive sentiment ranking.

4. The system of claim 1, wherein the communication of the user is a written conversation between the user and another person.

5. The system of claim 1, wherein the communication of the user is a conversation between the user and another person captured via a microphone.

6. The system of claim 1, wherein based on the determination that the sentiment is negative, the computer readable instructions further include:
accessing a user profile of another person communicating with the user;
identifying one or more media items present in the user profile of the another person and the user profile of the user;
playing the media item that has a highest average positive sentiment ranking for the another person and the user.

7. The system of claim 6, wherein the computer readable instructions further include increasing a positive sentiment ranking of the media item for the another person based on a determination that the sentiment of the another person became more positive during playback of the media item.

8. A method for adjusting media output based on mood analysis, comprising:
determining a sentiment of a user based on a communication of a user;
based on a determination that the sentiment is negative:
obtaining a media item having a positive sentiment ranking based on a user profile of the user;
monitoring the sentiment of the user during playback of the media item;
based on a determination that the sentiment of the user became more positive during playback the media item, increasing the positive sentiment ranking of the media item; and
based on a determination that the sentiment of the user did not become more positive during playback the media item, decreasing the positive sentiment ranking of the media item.

9. The method of claim 8, further comprising identifying a media item playing based on a determination that the sentiment is positive.

10. The method of claim 9, further comprising adding the media item to the user profile with a default positive sentiment ranking.

11. The method of claim 8, wherein the communication of the user is a written conversation between the user and another person.

12. The method of claim 8, wherein the communication of the user is a conversation between the user and another person captured via a microphone.

13. The method of claim 8, wherein based on the determination that the sentiment is negative, the method further comprises:
accessing a user profile of another person communicating with the user;
identifying one or more media items present in the user profile of the another person and the user profile of the user;
playing the media item that has a highest average positive sentiment ranking for the another person and the user.

14. The method of claim 13, wherein the method further comprises increasing a positive sentiment ranking of the media item for the another person based on a determination that the sentiment of the another person became more positive during playback the media item.

15. A computer program product comprising a computer readable storage medium having program instructions embodied therewith the program instructions executable by a computer processor to cause the computer processor to perform a method, comprising:
determining a sentiment of a user based on a communication of a user;
based on a determination that the sentiment is negative:
obtaining a media item having a positive sentiment ranking based on a user profile of the user;
monitoring the sentiment of the user during playback of the media item;
based on a determination that the sentiment of the user became more positive during playback the media item, increasing the positive sentiment ranking of the media item; and
based on a determination that the sentiment of the user did not become more positive during playback the media item, decreasing the positive sentiment ranking of the media item.

16. The computer program product of claim 15, wherein the method further comprises identifying a media item playing based on a determination that the sentiment is positive.

17. The computer program product of claim 16, wherein the method further comprises adding the media item to the user profile with a default positive sentiment ranking.

18. The computer program product of claim 15, wherein the communication of the user is a written conversation between the user and another person.

19. The computer program product of claim 15, wherein the communication of the user is a conversation between the user and another person captured via a microphone.

20. The computer program product of claim 15, wherein based on the determination that the sentiment is negative, the method further comprises:
accessing a user profile of another person communicating with the user;
identifying one or more media items present in the user profile of the another person and the user profile of the user;
playing the media item that has a highest average positive sentiment ranking for the another person and the user.
